(19) United States
(12) Patent Application Publication
(10) Pub. No.: US 2016/0160300 A1
(43) Pub. Date: Jun. 9, 2016

(54) APPARATUS AND METHOD FOR STRETCHING A PELT ON A PELT BOARD

(71) Applicant: JASOPELS A/S, Bording (DK)

(72) Inventor: Kurt Pedersen, Vinderup (DK)

(21) Appl. No.: 14/904,064

(22) PCT Filed: Jun. 26, 2014
(86) PCT No.: PCT/EP2014/063546

§ 371 Date: Jan. 8, 2016

(30) Foreign Application Priority Data
Jul. 10, 2013 (DK) PA201370388

(51) Int. Cl. C14B 15/06

(52) U.S. Cl. CPC C14B 15/06

(57) ABSTRACT

An apparatus is disclosed for stretching a pelt (1) on a pelt board (2) comprising a pelt board holder (7) for holding one end part (6) of the pelt board, pelt holders (5) arranged to grip at least a part of the lower periphery of the pelt when arranged on the pelt board, driver (11) for mutually displacing the pelt board placed in the pelt board holder (7) and the pelt holders (5) in a longitudinal direction of the pelt board (2), controller (12) for controlling the operation of the driver, and sensor (15) for sensing a characteristic property of the pelt board (2) and providing an output accordingly to the controller (12). Furthermore are disclosed methods of stretching pelts (1) accordingly.

The present invention relates to an apparatus and a method for stretching a pelt of a furred animal, in particular of a mink, prior to the drying of the pelt.

### BACKGROUND

It has been common practise to stretch pelts out before drying them in order to obtain a desired size of the pelt and a wrinkleless leather part of the pelt. For pelts of bred furred animals, in particular mink and fox, the pelt is usually stretched on a pelt board and secured to that prior to the drying.

Danish patent No. DK 169 525 discloses a machine for stretching of pelts on pelt boards, where a first stretch force is applied to stretch the pelt and, in case it is detected that the pelt length is close to the next higher classification size, a second, higher stretch force is applied to the pelt.

International patent application No. WO 02/44428 discloses a further development of this machine by adding a vibrating movement to the pelt during the stretching thereof, whereby an increased stretching of the pelt is achieved without causing damages to the pelt.

In the international patent application No. WO 2005/028682 a device for stretching of pelts is disclosed, where holding elements are provided to grip, engage and fasten the pelt along the whole periphery of the lower end of the pelt, thereby applying the stretch force more uniformly to the pelt and allowing for an increased stretching thereof. The pelt is secured in the stretched position by means of a sleeve drawn over the fur side of the pelt from a tip of the pelt board, i.e. from the nose end of the pelt.

One method of securing the pelt to the pelt board after stretching is disclosed in international application No. WO 01/62985 in which a sleeve is drawn over and around the pelt board and the pelt from the nose end of the pelt board, such that the internal side walls of the sleeve are in contact with the fur side of the pelt.

In the international patent application No. WO 2005/080607 the pelt is secured to the pelt board after stretching of the pelt by means of a winding material, such as a band, which is wound around the lower end part of the pelt, i.e. near the tail part.

The overall size of animal pelts, in particular of mink pelts, is increasing due to selective breeding of the animals in order to obtain larger pelts and it is an object of the present invention to provide an apparatus as well as a method for handling a pelt board designed for accommodating this development.

### BRIEF DESCRIPTION OF THE INVENTION

It has been realised by the inventor that an inventive solution to the problem of increasing overall size of pelts, in particular of mink pelts, is to provide the pelt boards with substantially identical upper, tapering parts and substantially the same cross-section of the lower end part but with different lengths of the lower end part. Thus, this solution to the problem of the increasing size of pelts is to increase the longitudinal extent of the lower part of the pelt board instead of increasing the longitudinal extent of the conical or tapering part. Thereby, the pelt boards of different lengths of the lower end part may fit into the same apparatus for stretching the pelt.

The length of the unstretched pelt is in some configurations applied to determine the force with which the pelt is stretched, and the length of the stretched pelt is in some configurations used for keeping statistics of the pelts being stretched and fixed to pelt boards by the apparatus. Thus, it would be advantageous to distinguish between the two or more lengths of pelt boards. In order to obtain this objective, the present invention provides an apparatus for stretching a pelt on a pelt board, the apparatus comprising a pelt board holder for holding one end part of the pelt board, pelt holders arranged to grip at least a part of the lower periphery of the pelt when arranged on the pelt board, driver for mutually displacing the pelt board placed in the pelt board holder and the pelt holders in a longitudinal direction of the pelt board, controller for controlling the operation of the driver, and sensor for sensing a characteristic property of the pelt board and providing an output accordingly to the controller. The sensor is preferably a contactless sensor but could alternatively be e.g. a sensor making contact with the surface of the pelt board to detect e.g. a depression in or a protrusion on the surface.

The sensor is in a preferred embodiment a magnetic sensor for detecting magnetic properties of a part of the pelt board, where e.g. longer pelt boards are provided internally with a magnetic material for the sensor to detect. Alternatives could be an optical sensor or a camera to capture surface identification marks, colour sensor to detect a difference in colour of the material used for manufacturing of the various types of pelt boards, an inductive sensor, and a capacitive sensor, where the different types of pelt boards are manufactured for the sensor to distinguish between the types and provide an output accordingly.

It is particularly preferred that the sensor is arranged to sensing a characteristic property of a lower part of the pelt board which normally will not be covered by the pelt when the sensor operates.

In a preferred embodiment of the present invention, the controller is arranged to control the driver in response to said output, such as for the determination of a suitable force to apply to the pelt for stretching it.

Alternatively or additionally, the controller may be arranged for obtaining statistical data regarding a plurality of pelts that are stretched by the apparatus, wherein the controller is arranged to encompass the output from the sensor in the statistical data obtained for the pelt arranged on the pelt board.

The apparatus according to the invention may further comprise a fixing arrangement for applying fixing means for fixing the pelt to the pelt board, in particular the sleeve disclosed in WO 01/62985 or the winding material disclosed in WO 2005/080607.

The present invention also relates to a method of stretching a pelt arranged on a pelt board supported at an end part by a pelt board holder, the method comprising the steps of gripping the lower periphery of the pelt by means of pelt holders, detecting a characteristic property of the pelt board by means of a sensor, and mutually displacing the pelt board holder and the pelt holders in a longitudinal direction of the pelt board so as to stretch the pelt, wherein the force with which the pelt board holder and the pelt holder are mutually displaced is determined in response to the detection of the characteristic property.

The present invention furthermore relates to a method of stretching a pelt arranged on a pelt board supported at an end part by a pelt board holder, the method comprising the steps of gripping the lower periphery of the pelt by means of pelt holders, detecting a characteristic property of the pelt board by means of a sensor, mutually displacing the pelt board holder and the pelt holders in a longitudinal direction of the pelt board so as to stretch the pelt, and obtaining statistical data regarding the pelts that are stretched by the apparatus, wherein the output from the sensor is encompassed in the statistical data obtained for the pelt arranged on the pelt board.

These two methods may naturally be combined, and it is preferred for either of the methods that said pelt is a mink pelt.

The methods may preferably be performed by means of an apparatus according the present invention as described herein.

### BRIEF DESCRIPTION OF THE DRAWING

An embodiment of the present invention is shown in the enclosed drawing of which

FIG. 1 is a schematic front view of a stretching apparatus with a shorter pelt board, and

FIG. 2 is a similar front view where a longer pelt board is arranged in the apparatus.

### DETAILED DESCRIPTION OF THE EMBODIMENT

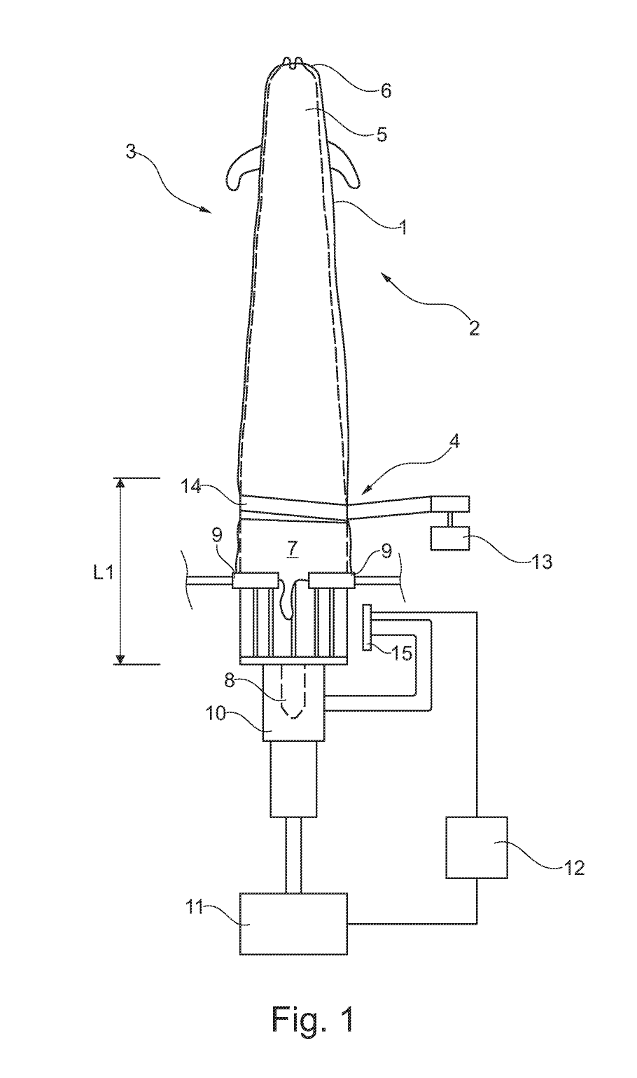

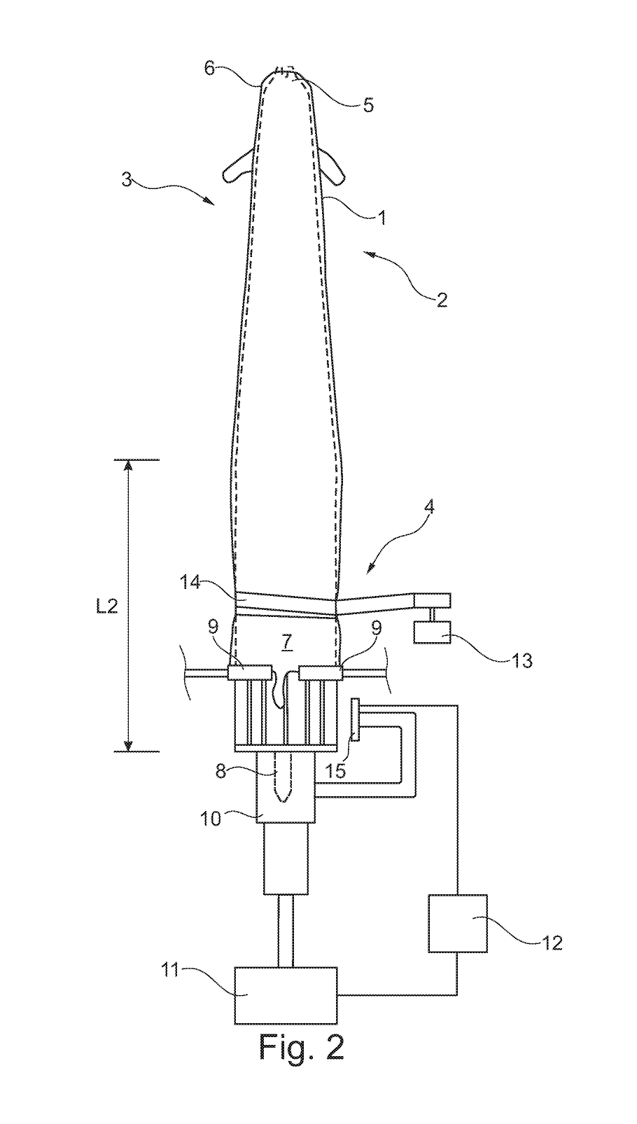

The stretching apparatus according to an embodiment of the invention is shown in FIGS. 1 and 2 for stretching of a fresh pelt 1 of a furred animal, in particular of a mink, for the purpose of drying the pelt 1 in the stretched position. The pelt 1 is arranged on a pelt board 2 which in itself is well-known in several variations, such as the traditional wooden pelt boards 2 and the newer hollow pelt boards 2 where drying air is distributed from the interior of the pelt board 2 through openings in the sides of the board. The fur side of the pelt 1 is on the exterior whereas the skin side, also known as the flesh side, is facing inwards towards the surface of the pelt board 2. The pelt board 2 has an upper, tapering part 3 and a lower, thick end part 4 of a substantially constant cross-section and the pelt 1 is drawn onto the pelt board 2 from the tip 5 of the tapering part 3 so that the nose end 6 of the pelt 1 is arranged at the tip 5 and the tail end 7 of the pelt 1 is situated typically near the transition between the tapering part 3 and the end part 4 of the pelt board 2. The lower end 4 of the pelt board is equipped with a projecting element 8, which for a number of expandable pelt boards 2 can be displaced in the longitudinal direction of the pelt board 2 to or from the lower end 4 in order to expand or contract the pelt board 2, respectively.

The apparatus is equipped with pelt holders 9 for gripping and retaining a lower periphery of the pelt 1, the pelt holders 9 being of a well-known design in the art. The projecting element 8 of the pelt board 2 is placed in a pelt board holder 10 that is formed with an opening to accommodate the projecting element 8 and a driver 11 is connected to the pelt board holder 10 to drive the pelt board holder 10 and thus the pelt board 2 towards the stationary pelt holders 9 gripping the lower periphery of the pelt 1, whereby the pelt 1 is stretched on the pelt board 2. The force of the driver 11 is controlled by a controller 12 of the apparatus from the type of pelt 1, i.e. male or female animal and possibly by the length of the pelt 1 prior to stretching thereof as disclosed in WO 2012/126467 A1. The force may alternatively be controlled partly or fully by the operator of the apparatus.

When the pelt 1 is stretched to its desired length, a fixing strip applier 13 is activated to wrap a fixing strip 14 around a lower part of the pelt 1 in order to fix the pelt 1 in the stretched position to the pelt board 2 such that the pelt 1 will remain in position during drying thereof. In alternative embodiments, the pelt 1 may be fixed by means of a sleeve that is drawn over the tip 5 of the pelt board 2 and down to the lower part of the pelt 1, where is clamps the pelt 1 to the pelt board 2 as disclosed in e.g. WO 01/62985 A1, or the pelt 1 may be fixed by means of stables applied through the pelt 1 and into a wooden pelt board 1.

The distance between the pelt holder 9 and the pelt board holder 10 before and after stretching of the pelt 1 is used by the controller 12 to compute the length of the unstretched pelt 1 and the stretched pelt 1, respectively, the length of the unstretched pelt 1 being applied to determine the force with which the driver 11 drives the pelt board holder 10 towards the pelt holders 9 for stretching the pelt 1, and the length of the stretched pelt 1 is used for keeping statistics of the pelts 1 being stretched and fixed to pelt boards 2 by the apparatus.

In order for the apparatus to be able to distinguish between pelt boards 2 of substantially the same cross-section of the lower end part 4 of the pelt board 2 but having different lengths L1, L2 of the lower part 4 which has a substantially constant cross-section, as shown in FIGS. 1 and 2, the apparatus is equipped with a contactless sensor 15 for detecting the magnetic properties of a position at the lower end part 4 of the pelt board 2 and provide an output to the controller 12 accordingly. The pelt boards 2 having a longer L2 lower part 4 are provided with a magnetic item inside each side of the lower part 4, such that the sensor 15 will detect the presence of the longer pelt board 2 and communicate that to the controller 12. This information indicates that the pelt 2 on the present pelt board 2 is longer by the distance L2−L1 than a pelt 2 on a shorter pelt board 2, i.e. with the shorter length L1 of the lower part 4, where the distance between the pelt holders 9 and the pelt board holder 10 is the same. Thus, the output from the sensor 15 to the controller 12 is applied by the controller 12 determine the longitudinal extend of the unstretched pelt 1 which in turn is employed to determine the suitable stretching force to be applied to the pelt 1 by means of the driver 11, which is then driven accordingly by the controller 12.

### REFERENCE NUMBERS AND SIGNS

1 pelt
2 pelt board
3 tapering part of pelt board
4 lower end part of the pelt board with substantially constant cross-section
5 tip of pelt board
6 nose end of the pelt
7 tail end of the pelt
8 projecting element of pelt board
9 pelt holders
10 pelt board holder
11 driver for driving the pelt board holder towards the pelt holders
12 controller
13 fixing strip applier
14 fixing strip
15 sensor
L1 Length of lower part of first pelt board with substantially constant cross-section
L2 Length of lower part of second pelt board with substantially constant cross-section

1. Apparatus for stretching a pelt on a pelt board comprising
a pelt board holder for holding one end part of the pelt board,
pelt holders arranged to grip at least a part of the lower periphery of the pelt when arranged on the pelt board,
driver for mutually displacing the pelt board placed in the pelt board holder and the pelt holders in a longitudinal direction of the pelt board,
controller for controlling the operation of the driver, and
sensor for sensing a characteristic property of the pelt board and providing an output accordingly to the controller, wherein said sensor is a contactless, magnetic sensor for detecting magnetic properties of a part of the pelt board.

2-3. (canceled)

4. The apparatus according to claim 1, wherein the sensor is arranged to sensing a characteristic property of a lower part of the pelt board.

5. The apparatus according to claim 1, wherein the controller is arranged to control the driver in response to said output.

6. Apparatus The apparatus according to claim 1, in which the controller is arranged for obtaining statistical data regarding a plurality of pelts that are stretched by the apparatus, wherein the controller is arranged to encompass the output from the sensor in the statistical data obtained for the pelt arranged on the pelt board.

7. The apparatus according to claim 1 further comprising a fixing arrangement for applying fixing means for fixing the pelt to the pelt board.

8. Method of stretching a pelt arranged on a pelt board supported at an end part by a pelt board holder, the method comprising the steps of
gripping the lower periphery of the pelt by means of pelt holders,
detecting a magnetic property of the pelt board by means of a sensor, and
mutually displacing the pelt board holder and the pelt holders in a longitudinal direction of the pelt board so as to stretch the pelt,
wherein the force with which the pelt board holder and the pelt holder are mutually displaced is determined in response to the detection of the magnetic property.

9. The method according to claim 8
further comprising
obtaining statistical data regarding the pelts that are stretched by the apparatus, wherein the output from the sensor is encompassed in the statistical data obtained for the pelt arranged on the pelt board.

10. The method according to claim 8, wherein said pelt is a mink pelt.

11. Method of stretching a pelt arranged on a pelt board supported at an end part by a pelt board holder, the method comprising:
providing apparatus according to claim 1
gripping the lower periphery of the pelt by means of the pelt holders,
detecting a magnetic property of the pelt board by means of the sensor, and
mutually displacing the pelt board holder and the pelt holders in a longitudinal direction of the pelt board so as to stretch the pelt,
wherein the force with which the pelt board holder and the pelt holder are mutually displaced is determined in response to the detection of the magnetic property

12. Apparatus according to claim 4, wherein the controller is arranged to control the driver in response to said output.

13. The apparatus according to claim 12, wherein the controller is arranged to control the force with which the driver will mutually displace the pelt board holder and the pelt holder so as to stretch the pelt.

14. The apparatus according to claim 5, wherein the controller is arranged to control the force with which the driver will mutually displace the pelt board holder and the pelt holder so as to stretch the pelt.

15. The method according to claim 9, wherein said pelt is a mink pelt.
